(19) United States
(12) Patent Application Publication
(10) Pub. No.: US 2026/0334370 A1
(43) Pub. Date: Oct. 29, 2026

(54) STRAW CHOPPER FOR A COMBINE HARVESTER

(71) Applicant: AGCO do Brasil Soluções Agrícolas Ltda., Jundiaí-São Paulo (BR)

(72) Inventor: Marcelo Carpenedo, Jundiaí-São Paulo (BR)

(21) Appl. No.: 19/656,153

(22) Filed: Apr. 23, 2026

(30) Foreign Application Priority Data
Apr. 28, 2025 (GB) 2506414

(51) Int. Cl. A01F 12/44

(52) U.S. Cl. CPC A01F 12/444

(57) ABSTRACT

A grain cleaning unit for a combine harvester comprises a line of belts. The line extends in a fore-aft direction of the combine harvester and the belts are inclined. A cleaning fan is in front of the line of belts for delivering an airflow in the fore-aft direction over the top and bottom faces of the belts.

### CROSS-REFERENCE TO RELATED APPLICATION

This application claims the benefit of the filing date of United Kingdom Patent Application 2506414.8, filed Apr. 28, 2025, the entire disclosure of which is incorporated herein by reference.

### FIELD

Embodiments of the present disclosure relate generally to combine harvesters, and in particular to a straw chopper spreader used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus.

After initial threshing, the separating apparatus includes a stratification pan that aims to stratify the material into a layered structure of grain at the bottom and light chaff and other material other than grain (MOG) at the top.

The cleaning system then separates the grain from the light chaff and MOG, and the grain is collected in a grain bin. From the grain bin, the grain can be unloaded, for example to a trailer pulled by a tractor which runs alongside the combine harvester.

The cleaning system of a combine harvester has had the same basic structure for many decades, using an oscillating system of sieves to produce an alternating movement which enables the undesired material to be moved out of the combine and the cleaned grain to be retained and stored inside the machine. The sieve group helps the grains to be separated from straw by combining this oscillatory movement with an air flow.

The oscillatory movement requires a complex mechanism with a design that is able to cope with the required accelerations and decelerations of the sieves. A simpler grain cleaning system would therefore be of interest.

### BRIEF SUMMARY

According to examples in accordance with this disclosure, there is provided a grain cleaning unit for a combine harvester, for receiving grain and material other than grain. MOG, from a threshing and separating system of the combine harvester. The grain cleaning unit comprises a frame and a line of belts mounted to the frame. Each belt extends around a respective pair of rotation shafts that extend in a lateral direction of the combine harvester. The line of belts extends in a fore-aft direction of the combine harvester and the belts are inclined relative to a direction of the line, with the belt height increasing in the fore-aft direction. A cleaning fan in front of the line of belts delivers an airflow in the fore-aft direction over the top and bottom faces of the belts.

The term "fore-aft" direction is intended to mean a direction from the front of the combine to the back of the combine. This corresponds to the general direction of flow of cut crop material through the combine.

This grain cleaning unit uses a line of belts to process the material received from the threshing and separating system. Instead of using oscillating sieves, such as the known chaffer sieve and lower sieve used in known grain cleaning systems, belts are used to convey the material in the rearward direction, and an airflow is used to separate the chaff and other MOG from the grains. This simplifies the hardware.

The top and bottom faces of the belts are for example parallel to each other. Thus, they may be simple belts between equally sized rollers at each end. Only one of the rotation shafts needs to be driven, but they could both be driven.

The belts are for example parallel to each other. Because they are inclined, they form a ladder like arrangement of parallel rungs, and air can flow between the rungs (between the bottom face of one belt and the top face of a next belt along the line of belts in the fore-aft direction).

Each belt may comprise surface ridges. These assist in carrying the chaff and MOG upwardly on the rising face (which is the top face) of the belts, and thereby assist in passing material along the line of belts.

In one arrangement, the surface ridges may be parallel to the direction in which the rotation shafts extend. Thus, they extend perpendicularly across the belts. This enables material to be driven most effectively upwardly by the belt.

In another arrangement the surface ridges may be inclined relative to the direction in which the rotation shafts extend. Thus, they are slanted across the width of the belts. This enables grain to slide down the surface ridges.

There are for example between 4 and 10 belts.

The belts are for example inclined by between 25 and 60 degrees relative to the direction of the line of belts. The line of belts is for example inclined relative to the horizontal. It may for example tilt upwardly in the fore-aft direction. The line of belts is for example inclined by between 5 and 20 degrees relative to the horizontal.

This disclosure also provides a combine harvester comprising a crop cutting head, a threshing and separating system and the grain cleaning unit as described above.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of this disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows a grain cleaning unit in a first perspective view;

FIG. 4 shows the grain cleaning unit of FIG. 3 in side view;

FIG. 5 shows a first belt design; and

FIG. 6 shows a second belt design.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a grain cleaning unit for a combine harvester comprising a line of belts. The line extends in a fore-aft direction of the combine harvester and the belts are inclined. A cleaning fan is in front of the line of belts for delivering an airflow in the fore-aft direction over the top and bottom faces of the belts.

This disclosure relates to the design of the cleaning system of a combine harvester. However, a general outline of a combine harvester will first be provided.

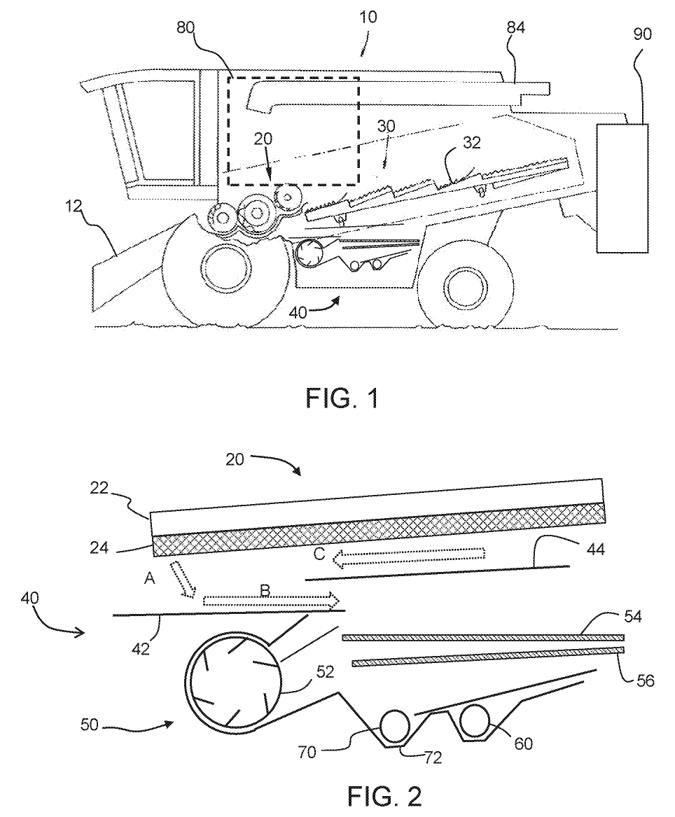

FIG. 1 shows a known combine harvester 10 to which this disclosure may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 (known as a feederhouse) at the front of the machine for attachment of a crop cutting head (known as the header, not shown). The header, when attached, serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. The straw chopper is used in combination with a straw spreader, and they are together represented as unit 90 in FIG. 1.

As mentioned above, instead of tangential flow threshing (and separating), axial threshing (and separating) is also known, and this disclosure may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear.

The threshing apparatus 20 does not remove all material other than grain, "MOG", from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that "forwardly" and "rearwardly" refer to direction relative to the normal forward direction of travel of the combine harvester.

When the material reaches the front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the denser grain sinks to the bottom layers adjacent stratification pan 42 and the lighter and/or larger MOG rises to the top layers.

For the design of grain cleaning unit 50 of FIG. 2, upon reaching the rear edge of the stratification pan 42, the crop stream falls onto the chaffer 54 which is also driven in a fore-and-aft oscillating motion. The chaffer 54 includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

All material which has not been collected by the filling auger 70 or returns auger exits the back of the combine harvester and passes to the chaff spreader. The chaff spreader receives the rejected material from the cleaning apparatus 40.

This disclosure relates to an alternative design of the grain cleaning unit, that replaces the sieve group 54, 56.

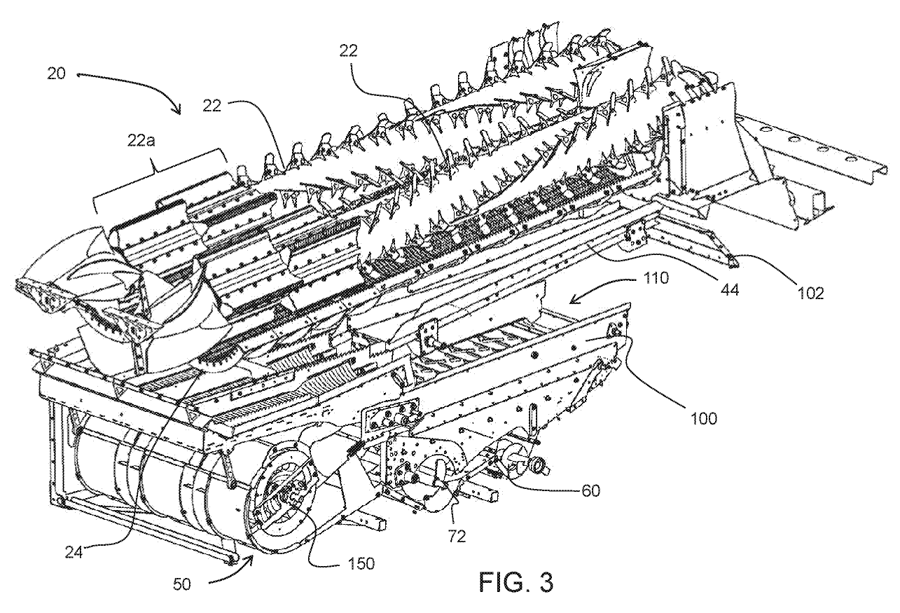

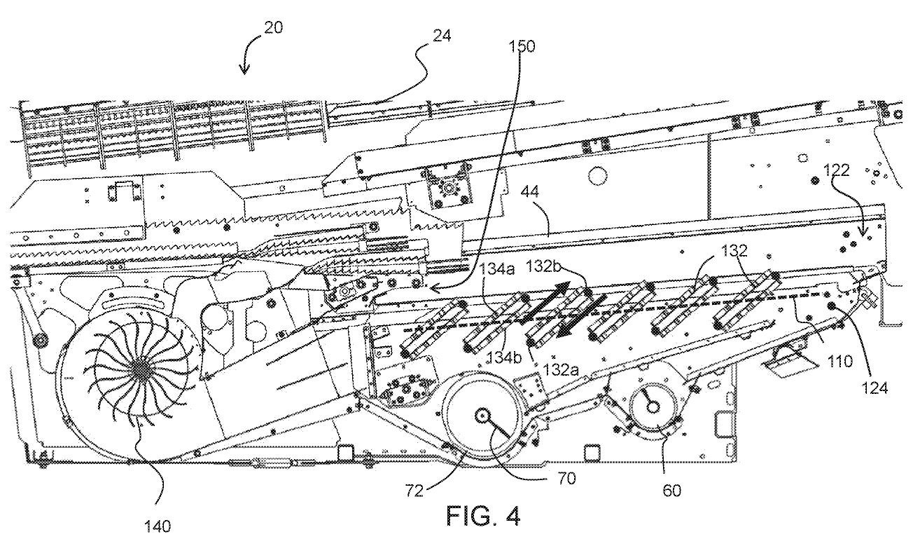

FIG. 3 shows a grain processing system in perspective view, based on the axial design of FIG. 2, and shows two axial rotors 22, the concave 24 and return pan 44 of FIG. 2. FIG. 4 shows the same design in side view.

There are two side-by-side axial rotors 22, driven with counter rotation. The axial rotors have an initial threshing section 22a and a downstream separating section. The cleaning system comprises a cleaning frame 100 onto which all components of the grain cleaning unit 50 are mounted. Beneath the return pan 44 there is a line 110 of inclined belts. They are arranged in a line along the cleaning frame 100. The cleaning frame 100 is static relative to the main combine chassis 102.

The line 110 of belts is mounted to the cleaning frame 100.

As shown in FIG. 4, each belt 132 extends around a respective pair of rotation shafts 132a, 132b. One or both rotation shafts is driven to drive the belt around the shafts. The incline is relative to the direction of the line 110 along which the belts are arranged. Each belt has an upper face 134a and a lower face 134b. The incline means the upper face faces the front of the combine and the lower face faces the back of the combine. Thus, the belts are inclined relative to a direction of the line 110 with the belt height increasing in the fore-aft direction, i.e. increasing towards the back of the combine.

The top end of one belt is vertically over the bottom end of the next. There may be an overlap between the top of belt and the bottom of the next belt, or there may be no overlap. In this way material dropping from the top of one belt is caught by the next belt.

The belts are for example inclined by between 15 and 75 degreed, such as between 25 and 60 degrees relative to the direction of the line 110 of belts.

In a most simple design, the upper and lower faces of each belt are equally spaced along their length, i.e. they are parallel. Thus, the rotation axes are then the same size and there are simply two rotation axes. However, there may be three or more rotation axes, i.e. the belt may have a more complex shape in side view.

The line 110 of belts extends generally in a fore-aft direction of the combine harvester. However, it is for example also inclined relative to the horizontal, in particular increasing in height towards the back of the combine. The line of belts is for example inclined by between 5 and 20 degrees relative to the horizontal.

The upper face of each belt is driven towards the back of the combine, i.e. the upper face drives material upwardly. Thus, the belt performs a lifting function to feed material from one belt to the next. The pair of arrows in FIG. 4 show the direction of belt travel for the belt that is located between the arrows.

The rotation shafts 132a, 132b at each end of the belts extend in a lateral direction of the combine harvester. Thus, the belts have a width across the width of the combine harvester, and a length (between the rotation shafts) that is in the fore-aft direction but with an incline.

An airflow is generated by a cleaning fan 140 in front of the line 110 of belts and the airflow is directed to the bottom and top faces 134a, 134b of the belts. Thus, the airflow passes between the belts, as well as over the top face of the first belt and under the bottom face of the last belt.

The material flow coming from the threshing and separating system 20 falls, by gravity, over the belts at an entrance end 150 and, by the continuous movement of the belts and the air flow moving among the belts, separates the undesired material (chaff and MOG such as leaves and straw) from the flow.

This material is conducted rearwardly to the back of the combine and the cleaned grains fall down to the trough 72 to be delivered to the storage tank by the filling auger 70.

On a rear portion 122 of the cleaning system there is a re-threshing area where the non-cleaned material, containing grains, falls down and is delivered to the processor to be processed again by the returns auger 60.

There are for example between 4 and 10 belts 132.

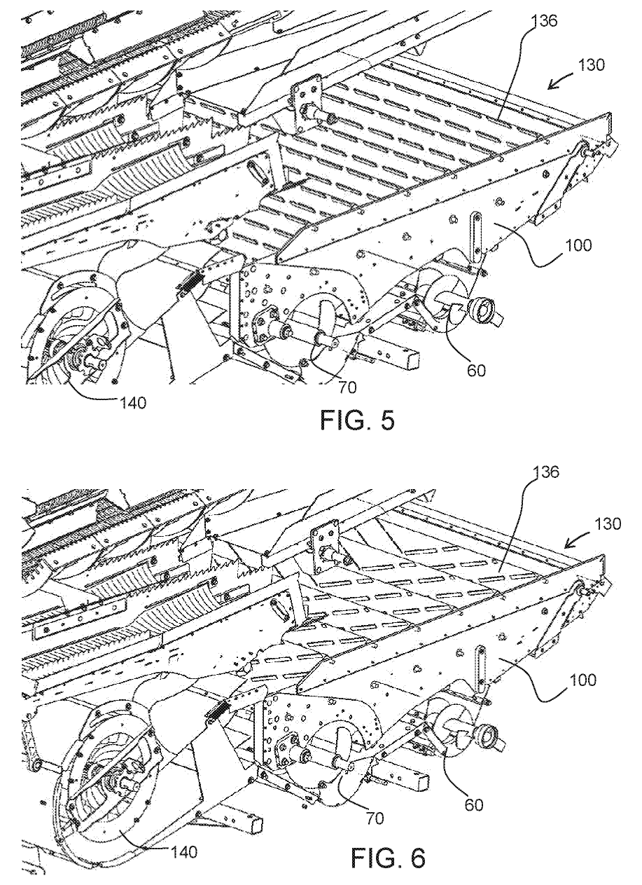

FIG. 5 shows a first design of the belts 130, in which each belt comprises surface ridges 136. The surface ridges in the example of FIG. 5 extend across the width of the belt. Thus, the surface ridges are parallel to the direction in which the rotation shafts extend.

The ridges comprise raised portions acting as pushing elements. The surface ridges are discontinuous across the belt width so that gaps are present through which grains can pass.

FIG. 6 shows a second design of the belts, in which the surface ridges 136 are inclined relative to the direction in which the rotation shafts extend. The surface ridges are again discontinuous diagonally across the belt width.

The angle, spacing and length of the surface ridges will be designed according to the material characteristics being cleaned. Similarly, the number of belts and their incline will be designed according to the desired functionality of the cleaning unit.

The rotation shafts of the belts keep the conveyor tensioned and provide traction for movement of the belts. The conveyor driving system may comprise a mechanical, hydraulic or electric drive.

The belt speed may be synchronized between all belts, but there may instead be different belt speeds. The belt speed or speeds may be adjusted according to the physical characteristics of the material being processed and the flow rates.

The teachings in this disclosure may be applied to any design of combine harvester. Thus, it does not rely on any particular threshing or separating design, and the examples above are only given to aid overall understanding.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

What is claimed is:

1. A grain cleaning unit for a combine harvester, for receiving grain and material other than grain. MOG, from a threshing and separating system of the combine harvester, the grain cleaning unit comprising:
a frame;
a line of belts mounted to the frame, wherein each belt extends around a respective pair of rotation shafts that extend in a lateral direction of the combine harvester, wherein the line of belts extends in a fore-aft direction of the combine harvester, wherein the belts are inclined relative to a direction of the line with the belt height increasing in the fore-aft direction;
a cleaning fan in front of the line of belts for delivering an airflow in the fore-aft direction over the top and bottom faces of the belts.

2. The grain cleaning unit of claim 1, wherein the top and bottom faces of the belts are parallel to each other.

3. The grain cleaning unit of claim 1, wherein the belts are parallel to each other.

4. The grain cleaning unit of claim 1, wherein each belt comprises surface ridges.

5. The grain cleaning unit of claim 4, wherein the surface ridges are parallel to the direction in which the rotation shafts extend.

6. The grain cleaning unit of claim 4, wherein the surface ridges are inclined relative to the direction in which the rotation shafts extend.

7. The grain cleaning unit of claim 1, wherein there are between 4 and 10 belts.

8. The grain cleaning unit of claim 1, wherein the belts are inclined by between 25 and 60 degrees relative to the direction of the line of belts.

9. The grain cleaning unit of claim 1, wherein the line of belts is inclined relative to the horizontal.

10. The grain cleaning unit of claim 9, wherein the line of belts is inclined by between 5 and 20 degrees relative to the horizontal.

11. A combine harvester comprising:
a crop cutting head;
a threshing and separating system; and
the grain cleaning unit of claim 1.
